(19) United States
(12) Patent Application Publication
(10) Pub. No.: US 2016/0350750 A1
(43) Pub. Date: Dec. 1, 2016

(54) MULTI-CHANNEL AUTHENTICATION, AND FINANCIAL TRANSFER METHOD AND SYSTEM USING MOBILE COMMUNICATION TERMINAL

(71) Applicant: Juhan KIM, Bucheon (KR)

(72) Inventor: Juhan KIM, Bucheon (KR)

(21) Appl. No.: 15/035,324

(22) PCT Filed: Nov. 6, 2014
(86) PCT No.: PCT/KR2014/010598

§ 371 Date: May 9, 2016

(30) Foreign Application Priority Data
Nov. 8, 2013 (KR) 10-2013-0135908

(51) Int. Cl. G06Q 20/38; G06Q 20/32; G06Q 20/40

(52) U.S. Cl. CPC G06Q 20/385; G06Q 20/405; G06Q 20/3829; G06Q 20/3276

(57) ABSTRACT

IDs and passwords will be no longer required, and certificates, security cards and OTP devices for authentication will become unnecessary. In addition, there will be no need for an operation which an individual should manage or take responsibility for. Thus, provided is a multi-channel authentication, and financial transfer method and system using a mobile communication terminal, for enabling a safe and convenient transfer through internet banking, comprising: step A1 for a client terminal transmitting transfer information which is input in a franchise server and requesting a netkey; step A2 for the franchise server storing transfer information, issuing a token, generating a netkey in which the token and a franchise identification (ID) are combined, and transmitting the netkey to the client terminal; step A3 for the client terminal displaying the received netkey and asking the franchise server to monitor token processing; step A4 for the franchise server monitoring token issuance information at predetermined time intervals and, if the token processing is completed, notifying the client terminal of the token processing completion; step A5 for the mobile communication terminal receiving the netkey displayed on the client terminal, transmitting the netkey to a smart safe, and receiving, from the smart safe, a processing result including an OTP; step A6 for the client server asking the franchise server to confirm the OTP after receiving the OPT which has been received by the mobile communication terminal in step A4; step A7 for the franchise server determining whether or not the OTP is valid on the basis of the OTP received from the client terminal, and determining whether or not the token processing occurs on the basis of the token received from the franchise server; and step A8 for the client terminal receiving the OTP confirmation result from the franchise server and displaying the result on a client display.

### TECHNICAL FIELD

The present invention relates to authentication and financial transfer method and system capable of solving a security risk and inconvenience in an existing authentication method by performing multi-channel authentication using a mobile communication terminal.

### BACKGROUND ART

As a mobile communication terminal provided with a camera is widely distributed, a two-dimensional barcode such as a QR code (registered trademark) can be read by the mobile communication terminal by executing an application that scans the barcode.

In recent years, as a mobile communication terminal equipped with Bluetooth (registered trademark) and NFC (registered trademark) which are near field communication of worldwide standards is widely distributed, data can be transmitted to the mobile communication terminal through the near field communication.

Financial transfer to another bank account can be conveniently performed through internet banking.

### DISCLOSURE

### Technical Problem

However, the internet banking is convenient, but there is a risk of being exposed to several methods of hacking individuals. In order to avoid such a risk, a certificate is stored in a portable storage device, and a user logs on to a financial site by using the certificate. Before the financial transfer to another bank account is performed, the user prepares for the hacking by inputting an OTP issued by a one-time password (OTP) device or a security card.

However, there is inconvenience that the certificate is regularly updated, and the updating of the certificate incurs costs in some cases.

However, the issuing of the OTP device incurs costs, and the OTP issued in the OTP device and an authentication server are not accurately synchronized depending on the state of the OTP device in some cases.

However, the individual needs to posses the portable storage device that stores the certificate, the OTP device and the security card, or the individual is responsible for managing these devices at the time of losing and leaking information.

There is an inconvenience that it is necessary to install a security program such that passwords of the certificate and numerals of the security card are exposed to keyboard hacking (key logging).

An object of the present invention is to provide a transfer method and a financial system having no necessity to perform an operation for which an individual is responsible by performing multi-channel authentication using a mobile communication terminal, unlike an existing financial system such as an ID, a password, a certificate, a security card and an OTP device which are responsibly managed by the individual and are responsible by the individual at the time of losing and leaking information.

### Technical Solution

According to one aspect of the present invention, there is provided a multi-channel authentication and financial transfer method using a mobile communication terminal. The method includes: A1 step of causing a client terminal to transmit input transfer information to a franchise server and to request a netkey; A2 step of causing the franchise server to store the transfer information, to issue a token, to generate a netkey acquired by combining the token with a franchise identification ID, and to transmit the generated netkey to the client terminal; A3 step of causing the client terminal to display the received netkey and to request the franchise server to monitor the processing of the token; A4 step of causing the franchise server to monitor token issuance information at a predetermined time interval, and to notify the client terminal that the processing of the token is completed when the processing of the token is completed; A5 step of causing the mobile communication terminal to receive the netkey displayed on the client terminal, to transmit the received netkey to a smart safe, and to receive a processing result including an OTP from the smart safe; A6 step of causing the client terminal to receive the OTP received by the mobile communication terminal and to request the franchise server to check the OTP; A7 step of the franchise server to determine whether or not the OTP received from the client terminal is valid, and to determine whether the token received from the franchise server is processed; and A8 step of the client terminal to receive the OTP check result from the franchise server, and to display the received OTP check result on a client display unit.

The step A5 may include: C1 step of causing the mobile communication terminal to transmit the received netkey to the smart safe server; C2 step of causing the smart safe server to determine whether or not the netkey is valid, to extract the token and franchise identification ID from the netkey, to inquiry about whether or not the franchise identification ID is a terminal of a subscriber who is contracted to use a service from a terminal information database (292), to acquire a personal identification ID when the franchise identification ID is the contracted terminal, to acquire a URL and an access code of the franchise server from the franchise information database by using the extracted franchise identification ID, to encrypt data such that at least the token, the personal identification ID and the access code is included in the acquired franchise URL, and to transmit the encrypted data to the franchise server; C3 step of causing the franchise server to receive the encrypted data, to complete the processing of the received token appropriately for the purpose of use, to update the fact that the processing of the token is completed when the processing of the token is completed, to issue and store the OTP, to extract transfer information corresponding to the token form transfer request information, and to transmit processing result data, as a response, to the smart safe server; C4 step of causing the smart safe server to transmit the processing result to the mobile communication terminal; and C5 step of casing the mobile communication terminal to display the transfer information and OTP.

In the C2 step, data may be encrypted with the acquired access code as a key such that a header parameter including at least the token and the personal identification ID and a body parameter including necessary data are included in the acquired franchise URL.

The C3 step may include: S1 step of causing the franchise serer to receive the encrypted data from the smart safe server, and to extract the personal identification ID and token from the data; S2 step of causing the franchise serer to determine the result of the S1 step; S3 step of causing the franchise serer to transmit an error message to the smart safe server when the determination result of the S2 step is abnormal; S4 step of causing the franchise serer to check whether the token is an already processed token or is a token within a valid time when the determination result of the S2 step is normal; S5 step of causing the franchise serer to determine the result of the S4 step; S6 step of causing the franchise server to transmit an error message to the smart safe server (200) when the determination result of the S5 step is abnormal; S7 step of causing the franchise server to issue the OTP when the determination result of the S5 step is normal; and S8 step of causing the franchise server to extract the transfer information corresponding to the token, and to transmit the issued OTP and the transfer information to the smart safe server.

The A7 step may include: S1 step of causing the franchise server to receive the OTP and the token from the client terminal in response to the OTP check request of the A6 step, and to compare the received OTP and token with information on the token issuance; S2 step of causing the franchise server to determine the result of the S1 step; S3 step of causing the franchise server to transmit an error message to the client terminal when the determination result of the S2 step is abnormal; S4 step of causing the franchise server to check whether or not the OTP is valid when the determination result of the S2 step is normal; S5 step of causing the franchise server to determine the result of the S4 step; S6 step of causing the franchise server to transmit an error message to the client terminal when the determination result of the S5 step is abnormal; S7 step of causing the franchise server to perform a transfer process to another bank account when the determination result of the S5 step is normal; and S8 step of causing the franchise server to transmit the fact that the transfer process is completed to the client terminal.

The mobile communication terminal may receive a QR code as the netkey in the A5 step.

Meanwhile, according to another aspect of the present invention, there is provided a multi-channel authentication and financial transfer system using a mobile communication terminal. The system includes: a mobile communication terminal; a smart safe server; a franchise server; and a client terminal that displays a QR code including a netkey on a screen.

Meanwhile, according to still another aspect of the present invention, there is provided a multi-channel authentication and financial transfer system using a mobile communication terminal. The system includes: a smart safe server that includes a netkey receiving function, an authenticating function, a franchise transmitting and receiving function, a result transmitting function, and a database that stores a personal information database, a terminal information database and a franchise information database. The personal information database includes a telephone number of the mobile communication terminal, and a personal unique identification ID, the terminal information database includes an identification number of the mobile communication terminal, and a telephone number, and the franchise information database includes a franchise ID, a franchise URL, and an access code.

Meanwhile, according to still another aspect of the present invention, there is provided a multi-channel authentication and financial transfer system using a mobile communication terminal. The system includes: a franchise server that includes a token issuance function of issuing a token, a token monitoring function of monitoring token issuance information at a predetermined time interval and notifying the client terminal that the processing of the token is completed when the processing of the token is completed, a token collecting and OTP issuing function of determining whether or not the token is valid and issuing an OTP, and an OTP checking and transfer processing function of receiving the OTP and token from the client terminal, checking whether or not the token is valid, and performing the transfer.

The franchise server may include a database which includes at least authentication information including at least a user ID, a name and a mobile telephone number, token issuance information including at least a token ID, a transfer request number, a token issuance time, a token processor and a token processing time, transfer request information including at least a transfer request number, a withdrawal account, a transfer amount of money and a deposit account, OTP issuance information including at least a transfer request number, an OTP, an OTP issuance time, an OTP failure number of times and an OTP processing time, bank statement information including at least a user ID, a transfer request number, a transaction date, deposit and withdrawal classification, a deposit amount of money, a withdrawal amount of money, a transaction memo and a balance.

### Effect of the Invention

When financial transfer is performed through internet banking of the related art, since a certificate, a security card and an OTP device are necessary and an individual is responsible for managing them, there are an inconvenience and an anxiety. Thus, when authentication is performed using a netkey and multi-channel authentication is performed by receiving an OTP by a mobile communication terminal, an ID or a password are not necessary any more, and a certificate, a security card and an OTP device which are used for authentication are not necessary. Since it is not necessary to perform an operation managed or responsible by the individual, the individual can safely and conveniently perform financial transfer through internet banking.

### DESCRIPTION OF DRAWINGS

FIG. 1 is a block diagram showing the configuration of a system in which a client terminal (400) according to an embodiment of the present invention requires a netkey.

FIG. 2 is a block diagram showing the configuration of a system in which a mobile communication terminal (100) according to the embodiment of the present invention requires the netkey.

FIG. 3 is a functional block diagram of the mobile communication terminal (100) according to the embodiment of the present invention.

FIG. 4 is a functional block diagram of a smart safe server (200) according to the embodiment of the present invention.

FIG. 5 is a functional block diagram of a franchise server (300) according to the embodiment of the present invention.

FIG. 6 is a flowchart showing an operation procedure of the system according to the embodiment of the present invention.

FIG. 7 is a flowchart showing an operation procedure of step A5 of FIG. 6.

FIG. 8 is a flowchart of a token collecting and OTP issuing function (330) of the franchise server (300).

FIG. 9 is a flowchart of an OTP checking and transfer processing function (340) of the franchise server (300).

FIG. 10 is a screen of the client terminal in A1 step of FIG. 6 of causing the client terminal (400) to input transfer request content and to request the netkey and financial transfer.

FIG. 11 is a screen of the client terminal (400) in A3 step of FIG. 6 in the client terminal (400).

FIG. 12 is a screen of a display unit (120) of the mobile communication terminal (100) in C1 step of FIG. 7.

FIG. 13 is a screen of the display unit (120) of the mobile communication terminal (100) in C5 step of FIG. 7.

FIG. 14 is a screen of a display unit of the client terminal (400) in A6 step of FIG. 6.

FIG. 15 is a screen of the display unit of the client terminal (400) in A8 step of FIG. 6.

### BEST MODE

Hereinafter, embodiments of the present invention will be described with reference to the drawings.

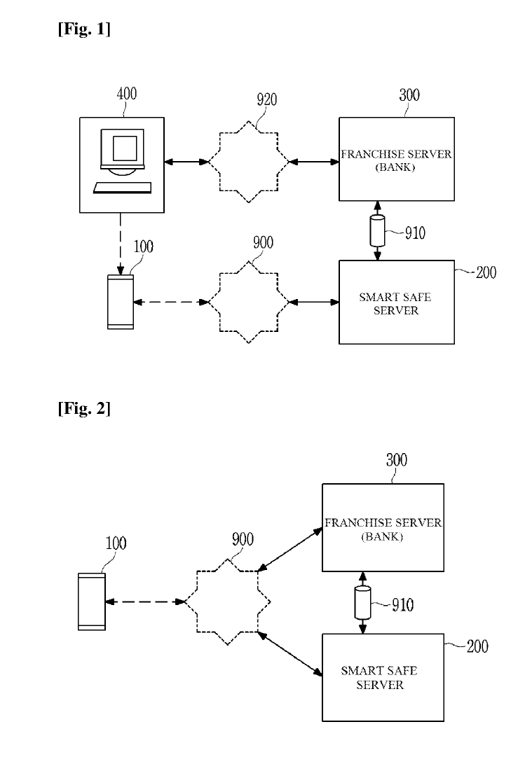

FIG. 1 is a block diagram showing the configuration of a system in which a client terminal 400 requests a netkey.

In FIG. 1, a mobile communication terminal 100, a smart safe server 200, a franchise server 300, a client terminal 400 that displays a QR code including a netkey on a screen, a network 900 such as a Wi-Fi network or a 3G or 4G network capable of communicating with the mobile communication terminal, a communication network 910 such as the Internet network, a dedicated line or a virtual private network (VPN) between the smart safe server and the franchise server, and a wired or wireless Internet network 920.

FIG. 2 is a block diagram showing the configuration of a system that requests a netkey from the mobile communication terminal 100.

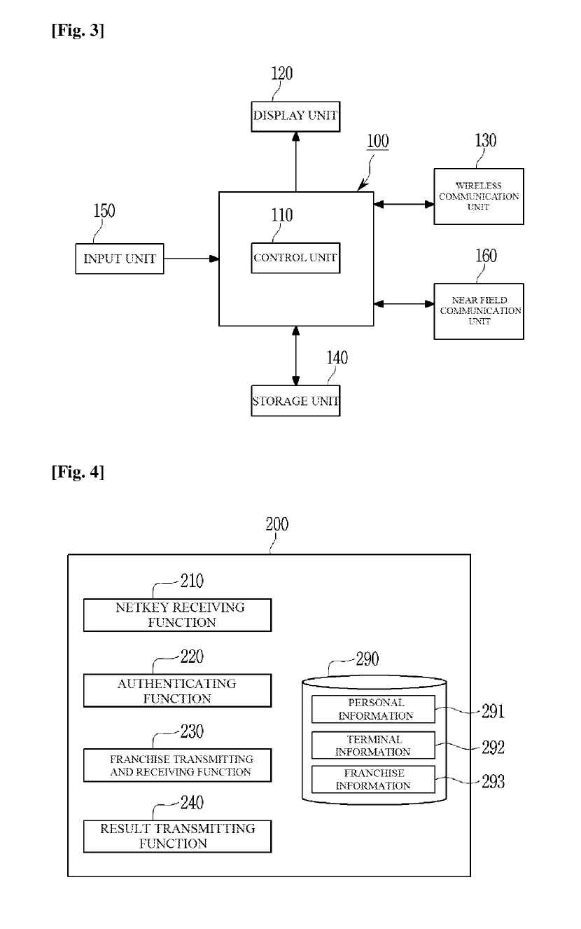

FIG. 3 is a configuration diagram of the mobile communication terminal 100 according to the embodiment of the present invention.

Referring to FIG. 3, the mobile communication terminal 100 according to the embodiment of the present invention includes a control unit 110, a display unit 120, a wireless communication unit 130, a storage unit 140, an input unit 150, and a near field communication unit 160.

The display unit 120 displays information under the control unit 110.

The wireless communication unit 130 performs a communication function by using the network 900.

The storage unit 140 may be a read only memory (ROM), universal subscriber Identity module (USIM), or a non-volatile mobile memory, and is a recording medium that stores an operating system of the mobile communication terminal, applications required in the embodiment of the present invention and files required to execute the application. The applications and files are executed by being read by the control unit 110.

The input unit 150 is input means such as a keypad or a touch device, and transmits an input of a user to the control unit 110.

The near field communication unit 160 is means for receiving the netkey in a non-contact manner, and receives the netkey and transmits the received netkey to the control unit 110.

FIG. 4 is a functional block diagram of the smart safe server 200 according to the embodiment of the present invention.

Referring to FIG. 4, the smart safe server 200 according to the embodiment of the present invention includes at least a netkey receiving function 210, an authenticating function 220, a franchise transmitting and receiving function 230, a result transmitting function 240, and a database 290 that stores a personal information database 291, a terminal information database 292, and a franchise information database 293.

The personal information database 291 stores at least a telephone number of the mobile communication terminal, and a unique identification ID.

The terminal information database 292 stores at least an identification number of the mobile communication terminal, and a telephone number.

The franchise information database 293 stores at least a franchise ID, a franchise URL, and an access code.

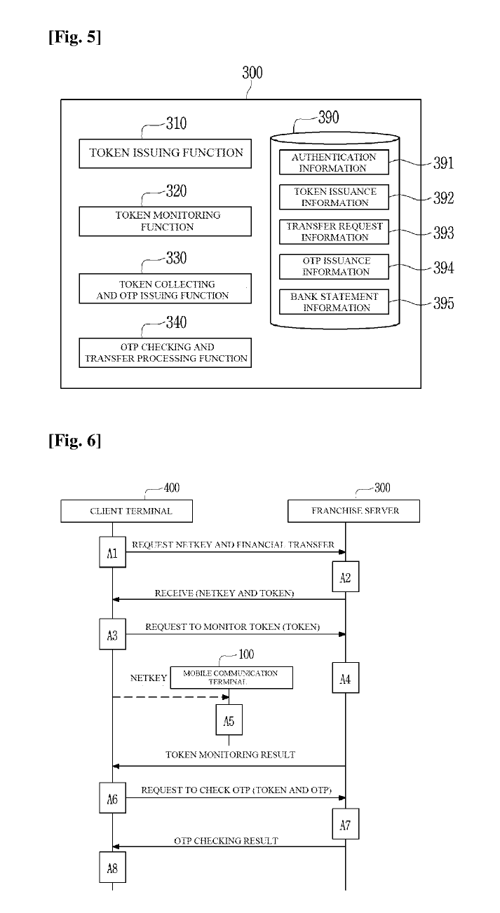

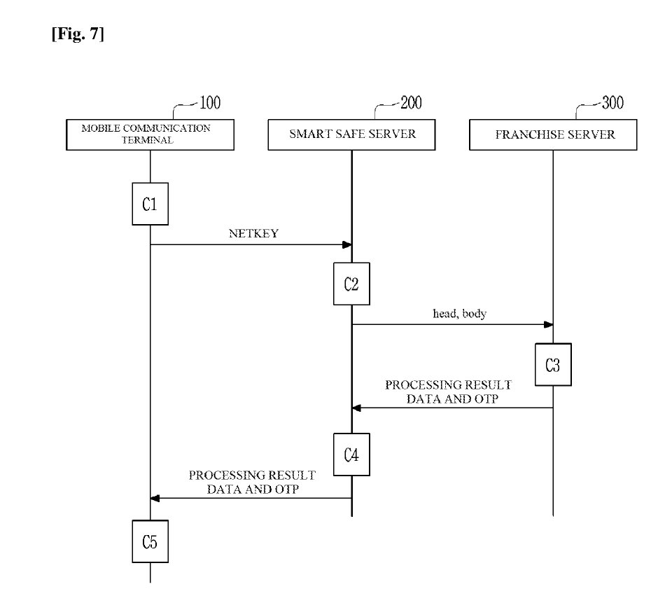

FIG. 5 is a functional block diagram of the franchise server 300 according to the embodiment of the present invention.

Referring to FIG. 5, the franchise server 300 according to the embodiment of the present invention includes at least a token issuing function 310, a token monitoring function 320, a token collecting and OTP issuing function 330, an OTP checking and transfer processing function 340, and a database 390 that stores authentication information 391, token issuance information 392, transfer request information 393, OTP issuance information 394, and bank statement information 395.

The authentication information 391 includes at least a user ID, a name and a mobile telephone number.

The token issuance information 392 includes at least a token ID, a transfer request number, a token issuance time, a token processor, and a token processing time.

The transfer request information 393 includes at least a transfer request number, a withdrawal bank account, a transfer amount of money, and a deposit account.

The OTP issuance 394 includes at least a transfer request number, an OTP, an OTP issuance time, an OTP failure number of times, and an OTP processing time.

The bank statement information 395 includes at least a user ID, a transfer request number, a transaction date, deposit and withdrawal classification, deposit amount of money, withdrawal amount of money, a transaction memo, and balance.

FIG. 6 is a flowchart showing the procedure in which the system according to the embodiment of the present invention is operated.

Referring to FIG. 6, when the transfer is required, the following steps are performed:

Step A1 of causing the client terminal to request the netkey to the franchise server 300 via the network 920 by inputting the transfer information through the operation performing on the input unit in a Web browser of the client terminal 400,

Step A2 of causing the franchise server 300 to store the transfer information received in step A1 as the transfer request information 393, to issue the token in the token issuance function 310, to add data to the token issuance information 392, to generate a netkey obtained by combining the token with the franchise identification ID, and to transmit the netkey and token as a response to the client terminal 400,

Step A3 of causing the client terminal 400 to display a QR code image of the netkey on a screen, and to request the franchise server 300 to monitor a processing state of the corresponding token,

Step A4 of causing the token monitoring function 320 of the franchise server 300 to monitor the token issuance information 392 at a predetermined time interval, and to notify the client 400 of the completion of the token processing when the processing of the token is completed,

Step A5 of causing the user to receive the netkey as the QR code and transmits the received netkey to the smart safe 200 by operating the input unit of the mobile communication terminal, and to receive the processing result.

Step A6 of displaying an OTP input screen in a client display unit, and to perform an OTP check request after inputting the OTP when the completion of the token processing is notified to the client terminal 400 in step A4,

Step A7 of determining whether or not the token is processed with the received OTP and the token and whether or not the input OTP matches with the validation of the OTP, and

Step A8 of receiving the OTP check result, and of displaying the received OTP check result on the client display unit.

FIG. 7 is a flowchart showing the procedure in which step A5 of FIG. 6 is operated.

Referring to FIG. 7, the following steps are performed: Step C1 of causing the communication terminal 100 to transmit the received netkey to the smart safe server 200,

Step C2 of causing the smart safe server 200 to perform the netkey receiving function 210 of receiving the netkey via the network 900, determining whether or not the netkey is valid and extracting the token and the franchise identification ID from the netkey, the authenticating function 220 of inquiring of the terminal information database 292 about whether or not the collected International Mobile Equipment Identify (IMEI) and Mobile Subscriber international ISDN Number (MSISDN) are terminals of subscribers who are under contract to a smart safe service and obtaining the personal identification ID from the personal information database 291 when it is determined to be the terminal under the contract, and the franchise transmitting and receiving function 230 of obtaining the access code and URL of the franchise server from the franchise information database 293 by using the franchise identification ID extracted in the netkey receiving function 210, encrypting a header parameter including at least the token and the personal identification ID and a body parameter including necessary data of the obtained franchise URL by using the obtained access code as a key, and transmitting the encrypted data to the franchise server 300 via the communication network 910,

Step C3 of causing the franchise server 300 to complete the token processing so as to be suitable for the purpose of the collected token, to update the token issuance information 392 to the completion of the token when the token processing is completed, to issue the OTP, and to store the issued OTP in the OTP issuance information 394, and to transmit the processing result data (at least transfer amount of money, deposit account, and OTP) to the smart safe server 200 as a response after the transfer information corresponding to the token is extracted from the transfer request information 393,

In step C4, if the processing result data is received, the smart safe server 200 performs the result transmitting function 240 of transmitting the processing result data to the mobile communication terminal 100 as the response, and

Step C5 of causing the mobile communication terminal 100 to receive the processing result data, and to display at least the transfer amount of money, the deposit account and the OTP on the display unit 120 of the mobile communication terminal 100.

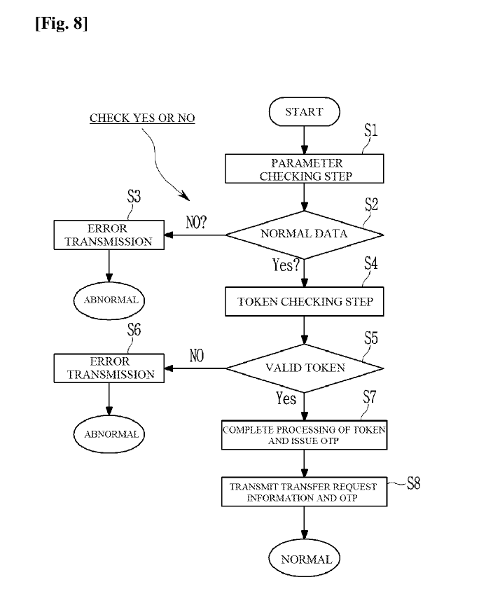

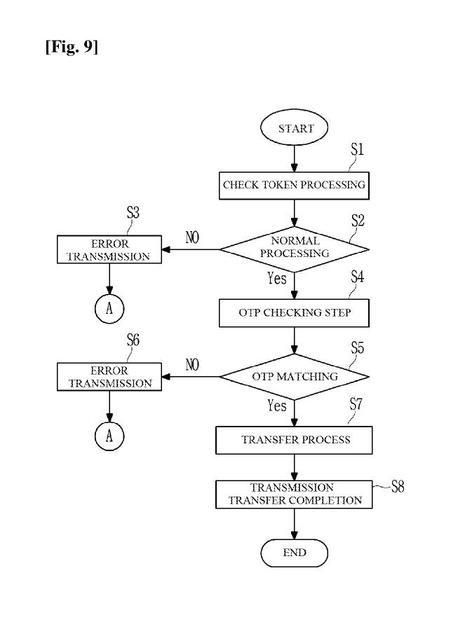

FIG. 8 is a flowchart of the token collecting and OTP issuing function 330 of the franchise server 300.

Referring to FIG. 8, the following steps are performed: Step S1 of causing the franchise server to receive the encrypted data from the smart safe server 200, to decrypt the data, to check the format of the data, and to check a parameter in order to extract the personal identification ID and the token from the parameter,

Step S2 of causing the franchise server to determine the result of step S1,

Step S3 of causing the franchise server to transmit the corresponding error message to the smart safe server 200 when the determination result of step S2 is abnormal,

Step S4 of causing the franchise server to acquire the token processor and the token issuance time by searching for the token issuance information 392 when the determination result of step S2 is normal, and to check whether the token is the processed token or is a token within a valid time,

Step S5 of causing the franchise server to determine the result of step S4,

Step S6 of causing the franchise server to transmit the corresponding error message to the smart safe server 200 when the determination result of step S5 is abnormal,

Step S7 of causing the franchise server to perform the token collecting and OTP issuing function 393 of changing the item of the token processor of the token issuance information 392 to the personal identification ID, to change the token processing time to a system time with the token as a key when the determination result of step S5 is normal, to issue the OTP, and to store the issued OTP in the OTP issuance information 393, and

Step S8 of causing the franchise server to extract the transfer information corresponding to the token from the transfer request information 393, and to transmit the issued OTP and at least the deposit account and the transfer amount of money to the smart safe server 200.

FIG. 9 is a flowchart of the OTP checking and transfer processing function 340 of the franchise server 300.

Referring to FIG. 9, the following steps are performed: Step S1 of causing the franchise server 300 to receive the OTP and the token from the client terminal 400 in response to the OTP check request of step A6 of FIG. 6, to extract the token processor, the token processing time and the transfer request number corresponding to the token received in the token issuance information 391, to check whether or not the values of the token processor and the token processing time are set, to determine to be an error when there are no values, and to determine that a processing user matches with a user who logs on when there are the values,

Step S2 of causing the franchise server to determine the result of step S1,

Step S3 of causing the franchise server to transmit the corresponding error message to the client terminal 400 when the determination result of step S2 is abnormal, to check the OTP by searching the OTP issuance information 393 for the OTP When the determination result of step S2 is normal, to extract the OTP issuance time and the OTP failure number of times, to determine whether or not the input OTP is the OTP within the valid time by comparing the OTP issuance time with the system current time, and to determine whether or not the failure number of times exceeds a predetermined number,

Step S5 of causing the franchise server to determine the result of step S4,

Step S6 of causing the franchise server to transmit the corresponding error message to the client terminal 400 when the determination result of step S5 is abnormal,

Step S7, which corresponds to A7 of FIG. 6, of causing the franchise server to update the fact that the OTP is processed in the OTP issuance information 394 when the determination result of step S5 is normal, to extract the transfer information corresponding to the transfer request number from the transfer request information 393, to store the extracted transfer information in the bank statement information 395, and to perform the transfer process to another bank account, and

Step S8 of causing the franchise server to transmit the fact that the transfer is completed to the client terminal 400.

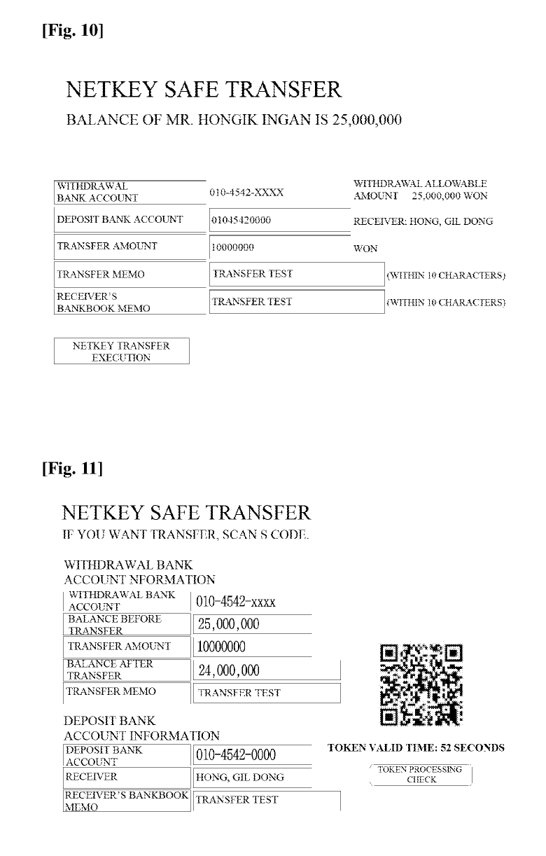

FIG. 10 is a screen of the client terminal 400 in step A1 of FIG. 6 of requesting the netkey and the transfer by inputting the transfer request content in the client terminal 400.

FIG. 11 is a screen of the client terminal 400 in step A3 of FIG. 6 of displaying the netkey as the QR code in the client terminal 400.

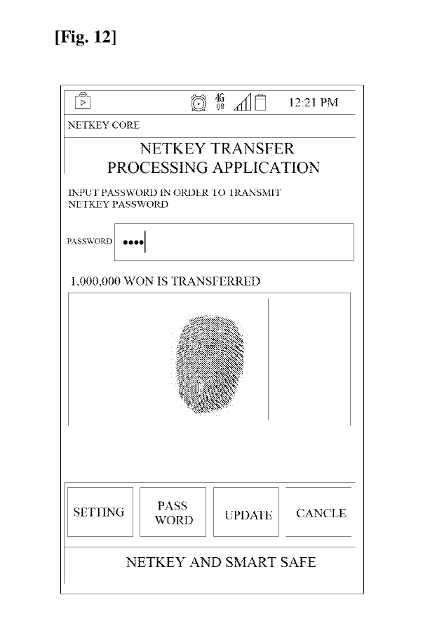

FIG. 12 is a screen of the display unit 120 of the mobile communication terminal 100 in step C1 of FIG. 7 of receiving the netkey by scanning the QR code of the display unit of the client terminal 400 with the mobile communication terminal 100 and transmitting the received netkey to the smart safe 200.

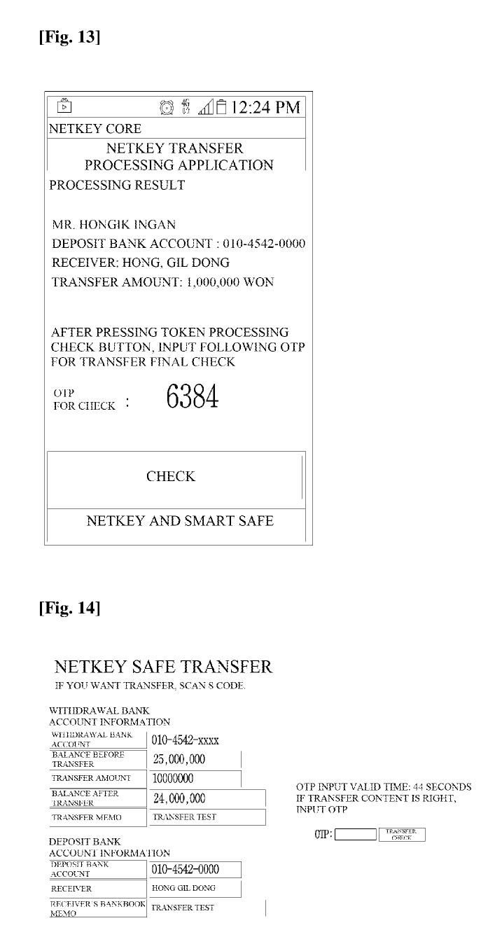

FIG. 13 is a screen of the display unit 120 of the mobile communication terminal 100 in step C5 of FIG. 7 of receiving and displaying the transfer content and the OTP after steps C1, C2, C3 and C4 of FIG. 7 are sequentially performed.

FIG. 14 is a screen of the display unit of the client terminal 400 in step A6 of FIG. 6 of notifying the client terminal 400 of the token processing result and displaying the OTP input screen when the franchise server 300 performs step A4 of FIG. 6 of performing the token monitoring function 320 by receiving the token monitoring request of step A3 of FIG. 6 and the token processing is completed.

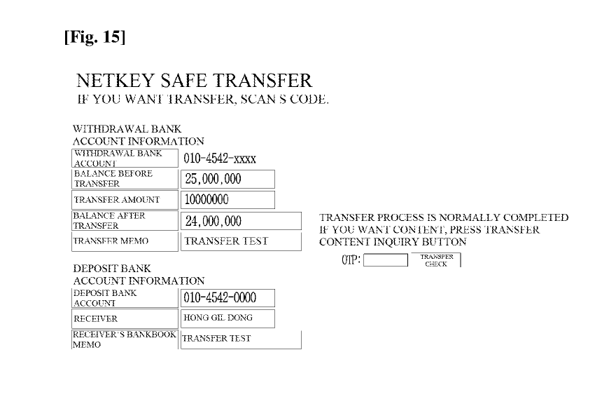

FIG. 15 is a screen of the display unit of the client terminal 400 in step A8 of FIG. 6 of receiving and displaying the result of step A7 of FIG. 6 of the OTP checking and transfer processing function 340 by the franchise server 300 by receiving the OTP check request after the displayed OTP is input on the input screen of FIG. 14 when the deposit account and the transfer amount of money displayed on the display unit 120 of the mobile communication terminal 100 of FIG. 13 are checked and the displayed content is normal.

The configuration of the above-described embodiment is merely a simple example, and the present invention is not limited to the aforementioned configuration.

The embodiment of the present invention described above is not implemented by only the device and method, and may be implemented using a program for realizing a function corresponding to the configuration of the embodiment of the present invention or a recording medium storing the program. Those skilled in the art to which the present invention pertains may easily implement such implementation from the aforementioned embodiment.

Although the embodiment of the present invention has been described in detail, the scope of the present invention is not limited to the embodiment. Various changes and modifications performed by those skilled in the art using the basic concept of the present invention are also included in the scope of the present invention.

The client terminal 400 expressed in the embodiment of the present invention is computing equipment such as a typical PC or a tablet PC including a storage unit, an input unit, a control unit, and a communication unit.

The client terminal 400 expressed in the embodiment of the present invention corresponds to the configuration of FIG. 1.

As to the client terminal 400 expressed in the embodiment of the present invention, the client terminal 400 in FIG. 2 may be the mobile communication terminal 100.

The franchise server and the smart safe server for implementing the present invention may be typical server equipment including a storage unit, an input unit, a control unit and a communication unit.

The token is issued in the franchise server 300, and the valid time may be set with a unique identifier in the franchise. The token is valid when the token is collected and is processed in the franchise that issues the token.

The netkey includes at least an ephemeral token and identification information of an issuer who issues the token, and the data type of the netkey is a data type that is mutually agreed that the token and the issuer identification information can be separated from each other in the franchise server that issues the token and the smart safe server that receives the netkey from the mobile communication terminal.

The smart safe is a server that stores and manages mobile communication terminal information and personal information for authenticating the subscriber which are capable of authenticating the user of the mobile communication terminal by specifying the user. The mobile communication terminal information includes information collected during the installation of the application which transmits the netkey in the mobile communication terminal by the user, that is, at least a telephone number, and a terminal identification number (IMEI: International Mobile Equipment Identity). Personal information input under the consent of the user is stored, and the personal information may be operated without depending on information from a mobile communication provider.

The terms such as that the token, the netkey, and the smart safe are terms defined in consideration of the function of the present invention, and may be changed depending on the intention of the user or the operator, or the precedent. Therefore, these terms should be defined based on the content of the entire specification.

### INDUSTRIAL APPLICABILITY

The present invention may be applied to an authentication and transfer system such as a bank, a stock firm, and an insurance company where financial transactions are conducted through internet.

1. A multi-channel authentication and financial transfer method using a mobile communication terminal, the method comprising:
an A1 step of causing a client terminal to transmit input transfer information to a franchise server and to request a netkey;
an A2 step of causing the franchise server to store the transfer information, to issue a token, to generate a netkey acquired by combining the token with a franchise identification ID, and to transmit the generated netkey to the client terminal;
an A3 step of causing the client terminal to display the received netkey and to request the franchise server to monitor the processing of the token;
an A4 step of causing the franchise server to monitor token issuance information at a predetermined time interval, and to notify the client terminal that the processing of the token is completed when the processing of the token is completed;
an A5 step of causing the mobile communication terminal to receive the netkey displayed on the client terminal, to transmit the received netkey to a smart safe, and to receive a processing result including an OTP from the smart safe;
an A6 step of causing the client terminal to receive the OTP received by the mobile communication terminal and to request the franchise server to check the OTP;
an A7 step of the franchise server to determine whether or not the OTP received from the client terminal is valid, and to determine whether the token received from the franchise server is processed; and
an A8 step of the client terminal to receive the OTP check result from the franchise server, and to display the received OTP check result on a client display unit.

2. The multi-channel authentication and financial transfer method using a mobile communication terminal according to claim 1, wherein the step A5 includes:
a C1 step of causing the mobile communication terminal to transmit the received netkey to the smart safe server;
a C2 step of causing the smart safe server to determine whether or not the netkey is valid, to extract the token and franchise identification ID from the netkey, to inquiry about whether or not the franchise identification ID is a terminal of a subscriber who is contracted to use a service from a terminal information database (292), to acquire a personal identification ID when the franchise identification ID is the contracted terminal, to acquire a URL and an access code of the franchise server from the franchise information database by using the extracted franchise identification ID, to encrypt data such that at least the token, the personal identification ID and the access code is included in the acquired franchise URL, and to transmit the encrypted data to the franchise server;
a C3 step of causing the franchise server to receive the encrypted data, to complete the processing of the received token appropriately for the purpose of use, to update the fact that the processing of the token is completed when the processing of the token is completed, to issue and store the OTP, to extract transfer information corresponding to the token form transfer request information, and to transmit processing result data, as a response, to the smart safe server;
a C4 step of causing the smart safe server to transmit the processing result to the mobile communication terminal; and
a C5 step of casing the mobile communication terminal to display the transfer information and OTP.

3. The multi-channel authentication and financial transfer method using a mobile communication terminal according to claim 2, wherein, in the C2 step, data is encrypted with the acquired access code as a key such that a header parameter including at least the token and the personal identification ID and a body parameter including necessary data are included in the acquired franchise URL.

4. The multi-channel authentication and financial transfer method using a mobile communication terminal according to claim 2, wherein the C3 step includes:
an S1 step of causing the franchise serer to receive the encrypted data from the smart safe server, and to extract the personal identification ID and token from the data;
an S2 step of causing the franchise serer to determine the result of the S1 step;
an S3 step of causing the franchise serer to transmit an error message to the smart safe server when the determination result of the S2 step is abnormal;
an S4 step of causing the franchise serer to check whether the token is an already processed token or is a token within a valid time when the determination result of the S2 step is normal;
an S5 step of causing the franchise serer to determine the result of the S4 step;
an S6 step of causing the franchise serer to transmit an error message to the smart safe server (200) when the determination result of the S5 step is abnormal;
an S7 step of causing the franchise serer to issue the OTP when the determination result of the S5 step is normal; and
an S8 step of causing the franchise server to extract the transfer information corresponding to the token, and to transmit the issued OTP and the transfer information to the smart safe server.

5. The multi-channel authentication and financial transfer method using a mobile communication terminal according to claim 1, wherein the A7 step includes:
an S1 step of causing the franchise server to receive the OTP and the token from the client terminal in response to the OTP check request of the A6 step, and to compare the received OTP and token with information on the token issuance;
an S2 step of causing the franchise server to determine the result of the S1 step;
an S3 step of causing the franchise server to transmit an error message to the client terminal when the determination result of the S2 step is abnormal;
an S4 step of causing the franchise server to check whether or not the OTP is valid when the determination result of the S2 step is normal;
an S5 step of causing the franchise server to determine the result of the S4 step;
an S6 step of causing the franchise server to transmit an error message to the client terminal when the determination result of the S5 step is abnormal;
an S7 step of causing the franchise server to perform a transfer process to another bank account when the determination result of the S5 step is normal; and
an S8 step of causing the franchise server to transmit the fact that the transfer process is completed to the client terminal.

6. The multi-channel authentication and financial transfer method using a mobile communication terminal according to claim 1, wherein the mobile communication terminal receives a QR code as the netkey in the A5 step.

7. A multi-channel authentication and financial transfer system using a mobile communication terminal, the system comprising:
a mobile communication terminal;
a smart safe serve; a franchise server; and
a client terminal that displays a QR code including a netkey on a screen.

8. A multi-channel authentication and financial transfer system using a mobile communication terminal, the system comprising:
a smart safe server that includes a netkey receiving function, an authenticating function, a franchise transmitting and receiving function, a result transmitting function, and a database that stores a personal information database, a terminal information database and a franchise information database,
wherein the personal information database includes a telephone number of the mobile communication terminal, and a personal unique identification ID,
the terminal information database includes an identification number of the mobile communication terminal, and a telephone number, and
the franchise information database includes a franchise ID, a franchise URL, and an access code.

9. A multi-channel authentication and financial transfer system using a mobile communication terminal, the system comprising:
a franchise server that includes a token issuance function of issuing a token, a token monitoring function of monitoring token issuance information at a predetermined time interval and notifying the client terminal that the processing of the token is completed when the processing of the token is completed, a token collecting and OTP issuing function of determining whether or not the token is valid and issuing an OTP, and an OTP checking and transfer processing function of receiving the OTP and token from the client terminal, checking whether or not the token is valid, and performing the transfer.

10. The multi-channel authentication and financial transfer system using a mobile communication terminal according to claim 9,
wherein the franchise server includes a database which includes at least authentication information including at least a user ID, a name and a mobile telephone number, token issuance information including at least a token ID, a transfer request number, a token issuance time, a token processor and a token processing time, transfer request information including at least a transfer request number, a withdrawal account, a transfer amount of money and a deposit account, OTP issuance information including at least a transfer request number, an OTP, an OTP issuance time, an OTP failure number of times and an OTP processing time, bank statement information including at least a user ID, a transfer request number, a transaction date, deposit and withdrawal classification, a deposit amount of money, a withdrawal amount of money, a transaction memo and a balance.
